(19) United States
(12) Patent Application Publication
(10) Pub. No.: US 2011/0063424 A1
(43) Pub. Date: Mar. 17, 2011

(54) STEREOSCOPIC IMAGE DISPLAY APPARATUS

(75) Inventors: Kenji Matsuhiro, Tokyo (JP); Michiyuki Kohno, Kanagawa (JP); Yoshihiro Yoshihara, Niigata (JP); Hiroshi Maruyama, Niigata (JP)

(73) Assignee: ARISAWA MFG. CO., LTD., Joetsu-shi (JP)

(21) Appl. No.: 12/879,039

(22) Filed: Sep. 10, 2010

(30) Foreign Application Priority Data
Sep. 14, 2009 (JP) 2009-212530

(51) Int. Cl. H04N 13/04

(52) U.S. Cl. 348/58; 348/E13.038

(57) ABSTRACT

Right and left eye images constituting each frame image are displayed on odd and even horizontal lines, or even and odd horizontal lines, respectively, of a display screen of a liquid crystal display. When the display switches from one frame to the next, the right and left eye images are switched between the odd and even horizontal lines, or the displayed right and left eye images are overwritten with the same images, so that the right and left eye images are interlaced with each other. Each time the right and left eye images are switched between the odd and even horizontal lines, the lighting state of the backlight is adjusted and the right and left sides of the polarized glasses are switched between two retarding states so that the right side is in one retarding state, the left side is in the other retarding state, and vice versa.

### BACKGROUND OF THE INVENTION

1. Field of the Invention

The present invention relates to a stereoscopic image display apparatus.

2. Background Art

Recently there has been significant effort to develop liquid crystal TVs employing a liquid crystal display. In an effort to increase the performance of such TVs, development of stereoscopic image display apparatuses using a liquid crystal display is under way.

A plurality of stereoscopic display methods have been proposed for stereoscopic image display apparatuses using a liquid crystal display apparatus. They include, e.g., the parallax barrier method, the lenticular lens method, and the “switch backlight” method which are well known in the art. These three methods are advantageous in that the viewer does not need to wear special glasses to view the image on the display apparatus. It is common, however, that images produced by the parallax barrier method and the lenticular lens method have the problem of decreased resolution (e.g., decreased horizontal resolution). Further, images produced by the “switch backlight” method tend to flicker.

One well known stereoscopic display method using special glasses is the shutter glasses method. This method produces images without the problem of decreased resolution and allows the image display apparatus to produce a wide viewing angle display. However, this method has disadvantages such as image flickering, decreased image brightness, and time delay between display of left and right eye images, which the viewer may find disturbing.

Recently, stereoscopic image display apparatuses have been proposed which use novel optical means to produce a stereoscopic image. For example, Japanese Laid-Open Patent Publication No. H10-63199 discloses a stereoscopic image display apparatus that eliminates the need for special glasses by employing novel optical means made up of two polarizing filters.

In the stereoscopic image display apparatus of the publication, a right-eye polarizing filter portion and a left-eye polarizing filter portion which have orthogonal polarizing directions are disposed side by side in front of the light source. The light emerging from these filter portions is converted into substantially parallel light by a Fresnel lens and directed to a liquid crystal display. Two polarizing filters are provided on the opposite surfaces of this liquid crystal display (i.e., on the light source side and on the viewer side of the liquid crystal display). Each of these polarizing filters includes linearly-polarizing filter line portions which alternate between two orthogonal polarizations and which each correspond to one of the horizontal scan lines. Each linearly-polarizing filter line portion of the polarizing filter on the light source side has a polarizing direction orthogonal to that of the facing linearly-polarizing filter line portion of the polarizing filter on the viewer side. Further, the stereoscopic image display apparatus is constructed so that the horizontal scan lines of the liquid crystal panel of the liquid crystal display, which correspond to the light transmission lines formed by the two polarizing filters, alternate between left and right eye image information.

That is, left and right eye images are displayed on the screen so that the odd and even horizontal scan lines represent, e.g., the left and right eye images, respectively. These left and right eye images are projected to the left and right eyes, respectively, of the viewer by the novel optical means.

This apparatus can present a stereoscopic image to the viewer while maintaining its quality even if the viewer moves slightly to the left or right of the proper stereoscopic position. Further, this apparatus avoids the problem of the horizontal resolution being reduced by half, which problem arises with the use of the parallax barrier method and the lenticular lens method.

Further, Japanese Laid-Open Patent Publication No. 2006-284873 discloses another stereoscopic image display apparatus employing a retarder serving as a novel optical means. This retarder has two regions facing two different areas, and the retarder acts on incident light so that the light transmitted through one of the two regions of the retarder has a polarization orthogonal to that of the light transmitted through the other region. The stereoscopic image display apparatus includes this retarder and a liquid crystal display which displays left and right eye images on different areas thereof to produce a parallax stereoscopic image as perceived by the viewer. This stereoscopic image display apparatus is known to produce a high resolution image that can be observed over a wide viewing angle.

However, the stereoscopic image display apparatus employing polarizing filters, described in the above Japanese Laid-Open Patent Publication No. H10-63199, suffers from a new problem. That is, since the images produced in accordance with the left and right eye image signals are always displayed at their respective fixed positions on the display screen, the vertical resolution of these images is reduced by half.

Further, the stereoscopic image display apparatus employing a novel retarder, described in the above Japanese Laid-Open Patent Publication No. 2006-284873, also suffers from a new problem. Specifically, when the center of the vertical length of the stereoscopic image display apparatus is observed from a certain viewing angle, part of the right eye image on the liquid crystal display reaches the left eye of the viewer through the left eye half-wavelength plate, thus causing crosstalk.

Thus, conventional stereoscopic image display apparatuses are not adapted to produce a high brightness screen image without flicker while maintaining its resolution. Therefore, there is a need for a new stereoscopic image display apparatus to accomplish this.

The present invention has been made in view of the foregoing problems. It is, therefore, an object of the present invention to provide a stereoscopic image display apparatus capable of producing a high brightness screen image without flicker while maintaining its resolution.

Other challenges and advantages of the present invention are apparent from the following description.

### SUMMARY OF THE INVENTION

According to the present invention, a stereoscopic image display apparatus projects parallax images to the right and left eyes of a viewer so that the viewer perceives a stereoscopic image.

The stereoscopic image display apparatus comprises a liquid crystal display including a liquid crystal panel sandwiched between a pair of polarizing plates, a backlight disposed on the rear side of the liquid crystal display, optical means disposed on the front side of the liquid crystal display, and polarized glasses to be worn by the viewer.

The liquid crystal display includes first image forming regions and second image forming regions and simultaneously displays the right eye image and the left eye image constituting each frame image in the first and second image forming regions, or second and first image forming regions, respectively, so that the right and left eye images are interlaced with each other. When the liquid crystal display switches from one frame image to the next, the right and left eye images are switched between the first and second image forming regions.

The liquid crystal display displays a new frame image every predetermined number of frame periods so that the right and left eye images of the frame image are displayed during the first one of the predetermined number of frame periods and then overwritten with the same right and left eye images during all subsequent ones of the predetermined number of frame periods.

The lighting state of the backlight is adjusted each time the right and left eye images are switched between the first and second image forming regions.

The optical means includes first polarizing regions and second polarizing regions.

The dimensions and position of each first polarizing region correspond to those of the corresponding first image forming region, and the dimensions and position of each second polarizing region correspond to those of the corresponding second image forming region.

The first and second polarizing regions are half-wavelength plates or are quarter-wavelength plates having perpendicular optical axes.

The polarized glasses include a right eye glass portion and a left eye glass portion.

Each time the right and left eye images are switched between the first and second image forming regions, the right and left eye glass portions are switched between two retarding states so that when the right eye glass portion is in one retarding state, the left eye glass portion is in the other retarding state, and vice versa.

### BRIEF DESCRIPTION OF THE DRAWINGS

FIG. 1 is a schematic exploded perspective view illustrating the construction of a stereoscopic image display apparatus according to the present embodiment.

FIG. 2 is a schematic exploded perspective view illustrating the construction of the right and left eye glass portions of the polarized glasses according to the present embodiment.

FIG. 3 is a schematic exploded perspective view illustrating the construction of the right and left eye glass portions (made up of ferroelectric liquid crystal elements) of the polarized glasses according to the present embodiment.

FIG. 4A is a diagram illustrating how the viewer perceives a frame image.

FIG. 4B is a diagram illustrating how the viewer perceives the next frame image after frame switching.

FIG. 5 is a diagram illustrating a common method of displaying on a liquid crystal display.

FIG. 6 is a diagram showing the operation of the stereoscopic image display apparatus 1 of the present embodiment.

### DETAILED DESCRIPTION OF THE EMBODIMENTS

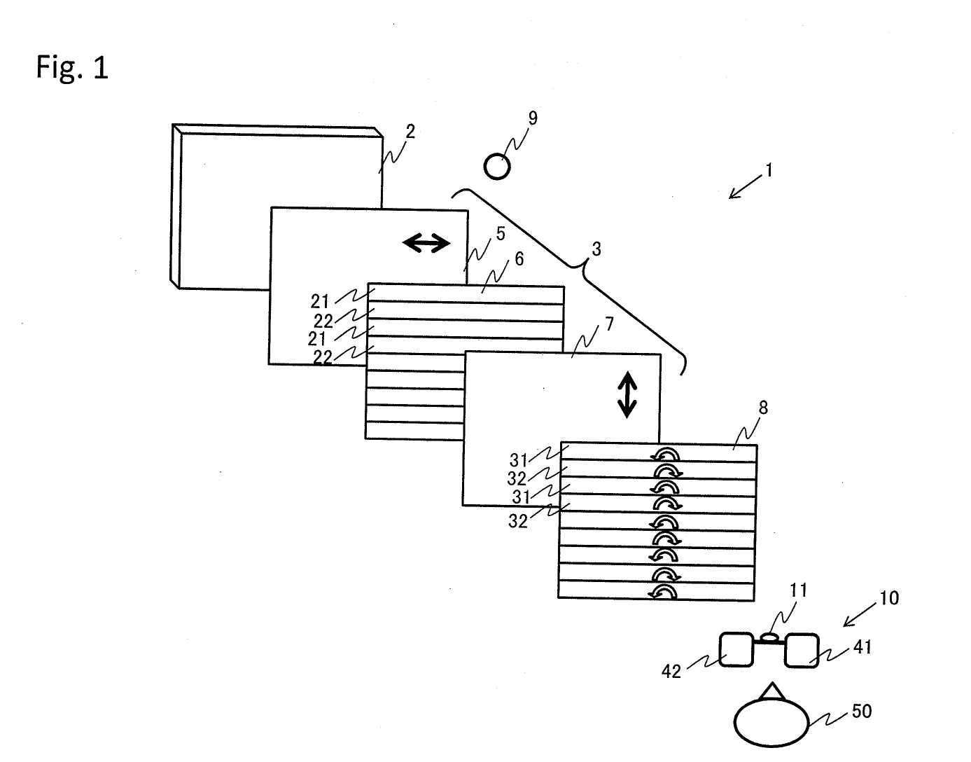

FIG. 1 is a schematic exploded perspective view illustrating the construction of a stereoscopic image display apparatus 1 according to an embodiment of the present invention. As shown in FIG. 1, the stereoscopic image display apparatus 1 includes a backlight 2, a liquid crystal display 3, and a retarder (optical means) 8 arranged in series in the order named within an enclosure (not shown). The stereoscopic image display apparatus 1 includes polarized glasses 10 which are to be worn by the viewer when viewing a stereoscopic image on the screen from the front side of the retarder 8. The enclosure of the liquid crystal display 3 is provided with an infrared radiator device 9 (described later), while the polarized glasses 10 are provided with an infrared sensor 11 for sensing infrared radiation emitted from the infrared radiator device 9.

A backlight 2 is disposed on the far side of the stereoscopic image display apparatus 1 from the viewer. When the stereoscopic image display apparatus 1 displays an image, or simply when the stereoscopic image display apparatus 1 is in use (which expression is hereinafter used), the backlight 2 emits white unpolarized light toward a surface of a polarizing plate 5 so as to produce a uniform light intensity across the surface. It should be noted that although in the present embodiment the backlight 2 is a surface light source, in other embodiments it may be a combination of point light sources such as LEDs and a condenser lens. Examples of condenser lenses include Fresnel lens sheets. A Fresnel lens sheet has concentric annular ridges and grooves (or prisms) on its front surface so that the Fresnel lens sheet refracts light from its focal point (located to the rear side of the sheet) into substantially collimated light which emerges from the front surface of the sheet.

The liquid crystal display 3 includes a liquid crystal panel 6 sandwiched and held between a pair of polarizing plates 5 and 7.

In the liquid crystal display 3, the polarizing plate 5 is disposed on the same side of the liquid crystal panel 6 as the backlight 2. The polarizing plate 5 has a transmission axis and an absorption axis orthogonal to the transmission axis. The polarizing plate 5 receives unpolarized light from the backlight 2, and transmits the components of light having a polarization axis parallel to the transmission axis of the plate and blocks the components of light having a polarization axis parallel to the absorption axis of the plate. It should be noted that the direction of the polarization axis of light is coincident with the vibration direction of the electric field of the light. The direction of the transmission axis of the polarizing plate 5 is parallel to the horizontal direction (as indicated by an arrow in FIG. 1) when the viewer faces the stereoscopic image display apparatus 1, as shown in FIG. 1.

The liquid crystal panel 6 includes liquid crystal sandwiched and held between glass substrates with transparent electrodes of ITO (Indium Tin Oxide) thereon. The liquid crystal panel 6 may be implemented with a TN (Twisted Nematic) mode liquid crystal panel or an IPS (In-Plane Switching) mode liquid crystal panel. In either way, the liquid crystal panel 6 is constructed such that the voltage applied to the liquid crystal can be changed to change its orientation so that the amount of light transmitted through the liquid crystal panel 6 can be adjusted by utilizing the action of the polarizing plates 5 and 7 disposed on the opposite surfaces of the panel.

The liquid crystal panel 6 is an important component of the stereoscopic image display apparatus 1 and is used to form images. In this panel, a pair of right and left eye images are simultaneously displayed on the screen. The display method will now be described. The image display portion of the liquid crystal panel 6 includes first image forming regions 21 and second image forming regions 22. These first and second image forming regions 21 and 22 are equal in area and stacked in the vertical direction in an interleaved manner so that they extend along the horizontal direction, as shown in FIG. 1.

For example, the right and left eye images constituting each frame image are displayed in the first and second image forming regions 21 and 22, or second and first image forming regions 22 and 21, respectively. When the liquid crystal display 3 switches from one frame to the next, the right and left eye images are switched between the first and second image forming regions 21 and 22. Thus, the right and left eye images of each frame image are displayed in such a manner that they are “interlaced” with each other. In the stereoscopic image display apparatus 1 of the present embodiment, the first and second image forming regions 21 and 22 are formed so that each region coincides with (or corresponds to) one of the horizontal lines of the image display on the liquid crystal panel 6.

Therefore, the right and left eye images constituting each frame image are displayed in, e.g., the first and second image forming regions 21 and 22 (which correspond to the odd and even horizontal lines, respectively, of the frame image). When the liquid crystal display 3 switches from one frame to the next, the right and left eye images are switched between the odd and even horizontal lines. Thus, the right and left eye images of each frame image are displayed in such a manner that they are “interlaced” with each other.

Though not shown in FIG. 1, the liquid crystal panel 6 has an outer frame extending along its periphery, and the first and second image forming regions 21 and 22 of the liquid crystal panel 6 are supported by this outer frame.

As described above, when the stereoscopic image display apparatus 1 is in use, the right and left eye images constituting a frame image are displayed in, e.g., the first and second image forming regions 21 and 22, respectively, of the liquid crystal panel 6. At that time, light is introduced into the first and second image forming regions 21 and 22 of the liquid crystal panel 6 through the polarizing plate 5. The transmitted light emerging from the first image forming region 21 represents the right eye image (and hence is hereinafter referred to as “right eye image light”). The transmitted light emerging from the second image forming region 22, on the other hand, represents the left eye image (and hence is hereinafter referred to as “left eye image light”). After the liquid crystal display 3 switches from this frame to the next frame, the right and left eye images of the frame image are displayed in the second and first image forming regions 22 and 21, respectively.

Referring to the above example, when the right and left eye images constituting a frame image are displayed in the first and second image forming regions 21 and 22, respectively, the right eye image light emerging from the first image forming region 21 and the left eye image light emerging from the second image forming region 22 are transmitted through the polarizing plate 7 (described later). As a result, they become linearly polarized and have polarization axes extending in specific directions. It should be noted that these directions of the polarization axes of the right eye image light and the left eye image light may be the same. In the example shown in FIG. 1, they coincide with the direction of the transmission axis of the polarizing plate 7 (described later).

The polarizing plate 7 is disposed on the viewer side of the liquid crystal display 6. This polarizing plate 7 receives the right eye image light and the left eye image light coming from the first and second image forming regions 21 and 22, respectively, and transmits the components of light having a polarization axis parallel to the transmission axis of the plate and blocks the components of light having a polarization axis parallel to the absorption axis of the plate (i.e., perpendicular to the transmission axis of the plate). It should be noted that the direction of the transmission axis of the polarizing plate 7 is perpendicular to the horizontal direction (as indicated by an arrow in FIG. 1) when the viewer faces the stereoscopic image display apparatus 1, as shown in FIG. 1.

The retarder 8 includes first polarizing regions 31 and second polarizing regions 32. As shown in FIG. 1, the dimensions and position of each first polarizing region 31 correspond to those of the corresponding first image forming region 21 of the liquid crystal panel 6, and the dimensions and position of each second polarizing region 32 correspond to those of the corresponding second image forming region 22 of the liquid crystal panel 6.

Therefore, when the stereoscopic image display apparatus 1 is in use and a frame image (e.g., an odd frame image) is displayed, the first polarizing regions 31 receive, e.g., the right eye image light emerging from the first image forming regions 21, and the second polarizing regions 32 receive, e.g., the left eye image light emerging from the second image forming regions 22. After the liquid crystal display 3 switches from this frame to the next frame (an even frame), on the other hand, the first polarizing regions 31 receive the left eye image light emerging from the first image forming regions 21, and the second polarizing regions 32 receive the right eye image light emerging from the second image forming regions 22.

In the stereoscopic image display apparatus 1 of the present embodiment, the first and second image forming regions 21 and 22 are formed so that each region coincides with (or corresponds to) one of the horizontal lines of the image display on the liquid crystal panel 6, as described above.

Therefore, each first polarizing region 31 of the retarder 8 corresponds to one of the odd horizontal lines of each displayed frame image, and each second polarizing region 32 of the retarder 8 corresponds to one of the even horizontal lines of each displayed frame image.

Further, through not shown, light shielding portions may be provided on the surface of the retarder 8 facing the liquid crystal display 3 in such a manner that these light shielding portions extend along and cover the boundaries between the first and second polarizing regions 31 and 32. With this arrangement, the right or left eye image light incident to each second polarizing region 32 of the retarder 8 can be prevented from leaking to the adjacent first polarizing regions 31, since the light shielding portions extending along the boundaries between these polarizing regions absorb and prevent the leaked light from reaching beyond the boundaries.

Likewise, the right or left eye image light incident to each first polarizing region 31 of the retarder 8 can be prevented from leaking to the adjacent second polarizing regions 32, since the light shielding portions extending along the boundaries between these polarizing regions absorb and prevent the leaked light from reaching beyond the boundaries. Thus, the light shielding portions provided on the retarder 8 act to reduce crosstalk between the right eye image light and the left eye image light emitted from the stereoscopic image display apparatus 1.

The first polarizing regions 31 of the retarder 8 receive linearly-polarized right or left eye image light having a polarization axis perpendicular to the horizontal direction. The first polarizing regions 31 convert this incident right or left eye image light into counterclockwise circularly polarized light. Further, the second polarizing regions 32 convert incident right or left eye image light into clockwise circularly polarized light.

Therefore, the right or left eye image light emerging from the first polarizing regions 31 and that emerging from the second polarizing regions 32 are circularly polarized in opposite directions, as indicated by arrows in FIG. 1. It will be noted that the arrows shown in the retarder 8 in FIG. 1 schematically show the directions of rotation of the circularly polarized light from the retarder 8.

Each first polarizing region 31 of the retarder 8 is made up of a quarter-wavelength plate having an optical axis rotated 45° counterclockwise with respect to the horizontal direction, and each second polarizing region 32 is made up of a quarter-wavelength plate having an optical axis rotated 45° clockwise with respect to the horizontal direction. It will be noted that the optical axis of a quarter-wavelength plate (e.g., a first polarizing region 31 or a second polarizing region 32) as used herein refers to the fast or slow axis of light traveling through the plate.

It should be noted that, instead of quarter-wavelength plates having perpendicular optical axes, as described above, the retarder may include half-wavelength plates having an optical axis rotated 45° counterclockwise with respect to the horizontal direction (which plates form first polarizing regions) and further include glass or resin members having substantially no retarding properties (which members form second polarizing regions).

In this case, the image light emerging from the first polarizing regions of the retarder is linearly polarized light having an optical axis rotated 90° with respect to the optical axis of the incident linearly polarized image light, and the image light from the second polarizing regions is linearly polarized light having an optical axis coincident with the optical axis of the incident linearly polarized image light. Therefore, the right and left eye glass portions (or right and left lenses) of the polarized glasses may be made up of suitable liquid crystal elements and polarizing plates to selectively transmit or block the image light from the first polarizing regions and from the second polarizing regions. In this way the stereoscopic image display apparatus can achieve the same function as described above.

Further, the stereoscopic image display apparatus 1 may have a diffusing plate disposed between the retarder 8 and the viewer, which plate diffuses the right and left eye image light from the first and second polarizing regions 31 and 32 in at least one of the horizontal and vertical directions. This diffusing plate may be a lenticular lens sheet including an array of cylindrical convex lenses extending in the horizontal or vertical direction. Or it may be a lens array sheet including a planar array of convex lenses.

In order to view a stereoscopic image on the stereoscopic image display apparatus 1, the viewer 50 wears the polarized glasses 10 to receive the right and left eye image light, separately, from the stereoscopic image display apparatus 1. The polarized glasses 10 includes a right eye glass portion 41 and a left eye glass portion 42 corresponding to the right and left eyes, respectively, of the viewer 50.

The right and left eye glass portions 41 and 42 are made up of TN mode liquid crystal elements or ferroelectric liquid crystal elements which can be electrically driven and which have mutually different initial liquid crystal orientations. These right and left eye glass portions, together with a drive unit (not shown) for the liquid crystal elements, are fixed to the frame of the polarized glasses 10.

As described above, the frame of the polarized glasses 10 is also provided with the infrared sensor 11. When the liquid crystal display 3 switches from one frame to the next, the infrared radiator device 9 provided on the liquid crystal display 3 emits infrared radiation. The infrared sensor 11 senses this infrared radiation and causes the liquid crystal element drive unit to drive the liquid crystal elements of the right and left eye glass portions 41 and 42.

More specifically, when the liquid crystal display 3 switches from one frame to the next, the infrared radiator device 9 provided on the liquid crystal display 3 emits infrared radiation serving as a synchronization signal. The infrared sensor 11 of the polarized glasses 10 receives this infrared radiation serving as the synchronization signal, so that the polarized glasses 10 detects the fact that the liquid crystal display 3 has switched to the next frame. The liquid crystal elements of the right and left eye glass portions 41 and 42 then begin to be driven to respond to this frame switching.

In the stereoscopic image display apparatus 1 of the present embodiment, the wireless system formed by the infrared radiator device 9 of the liquid crystal display 3 and the infrared sensor 11 of the polarized glasses 10 is used to synchronize the drive of the liquid crystal elements of the right and left eye glass portions 41 and 42 of the polarized glasses 10 with frame switching in the liquid crystal display 3. However, instead of such a wireless system using infrared radiation, the stereoscopic image display apparatus may employ a system in which the drive circuit of the liquid crystal display 3 is wire-connected to the drive unit for the right and left eye glass portions 41 and 42 of the polarized glasses 10, and the drive of the right and left eye glass portions 41 and 42 is controlled in accordance with a command from the drive circuit of the liquid crystal display 3.

The right and left eye glass portions 41 and 42 of the polarized glasses 10 are made up of TN liquid crystal elements or ferroelectric liquid crystal elements which can be electrically driven.

It should be noted that the right and left eye glass portions 41 and 42 may be made up of STN (Super Twisted Nematic) liquid crystal elements or antiferroelectric liquid crystal elements which can be electrically driven. Whereas TN liquid crystal has a twist angle of approximately 90°, STN liquid crystal has a twist angle of approximately 270°. As a result, STN liquid crystal elements have faster response times than TN liquid crystal elements. Antiferroelectric liquid crystal elements employ liquid crystal of antiferroelectric phase and allow for very high speed operation.

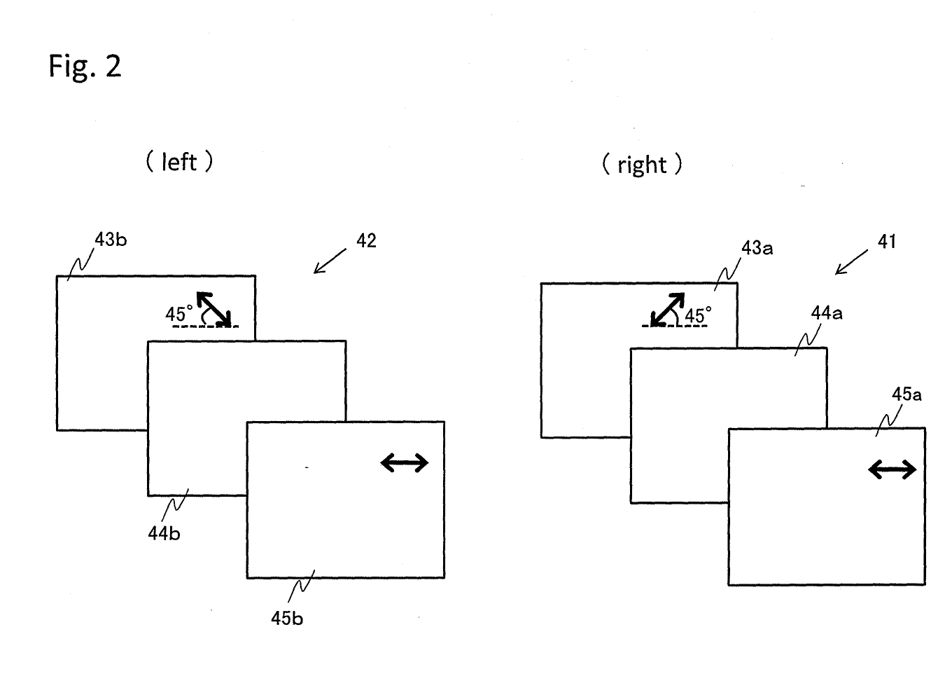

FIG. 2 is a schematic exploded perspective view illustrating the construction of the right and left eye glass portions 41 and 42 made up of TN mode liquid crystal elements. The right eye glass portion 41 of the polarized glasses 10 includes a quarter-wavelength plate 43a, a TN liquid crystal cell 44a, and a polarizing plate 45a arranged in series in the order named. The left eye glass portion 42, on the other hand, includes a quarter-wavelength plate 43b, a TN liquid crystal cell 44b, and a polarizing plate 45b arranged in series in the order named. These right and left eye glass portions 41 and 42 and a drive unit (not shown), etc. are fixed to the frame of the polarized glasses 10.

When the viewer 50 wears the polarized glasses 10 of the present embodiment and faces the liquid crystal display 3, the optical axis of the quarter-wavelength plate 43a of the right eye glass portion 41 is rotated 45° counterclockwise with respect to the horizontal direction, and the transmission axis of the polarizing plate 45a is parallel to the horizontal direction. The TN liquid crystal cell 44a has an initial liquid crystal orientation so that when no voltage is applied to the cell 44a, the cell 44a rotates incident linearly polarized light counterclockwise by 90° (that is, the light emerging from the cell 44a is rotated counterclockwise by 90° with respect to the incident light). When the TN liquid crystal cell 44a is driven into the so-called ON state (a liquid crystal orientation state) by the drive unit described above, the cell 44a loses its optical rotating properties and therefore the incident linearly polarized light is transmitted through the cell 44a without change in characteristics.

On the other hand, the optical axis of the quarter-wavelength plate 43b of the left eye glass portion 42 is rotated 45° clockwise with respect to the horizontal direction, and the transmission axis of the polarizing plate 45b is parallel to the horizontal direction. The TN liquid crystal cell 44b has an initial liquid crystal orientation so that when no voltage is applied to the cell 44b, the cell 44b rotates incident linearly polarized light clockwise by 90° (that is, the light emerging from the cell 44b is rotated clockwise by 90° with respect to the incident light). When the TN liquid crystal cell 44b is driven into the so-called ON state (a liquid crystal orientation state) by the drive unit described above, the cell 44b loses its optical rotating properties and therefore the incident linearly polarized light is transmitted through the cell 44b without change in characteristics.

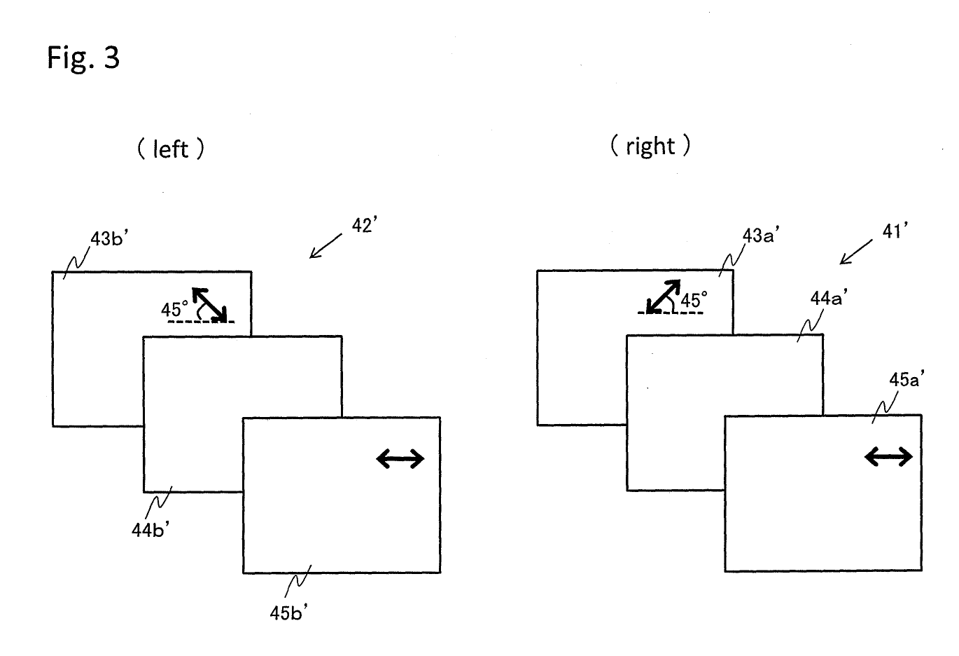

In another example, the polarized glasses 10 may include, instead of the right and left eye glass portions 41 and 42, a right eye glass portion 41′ and a left eye glass portion 42′ made up of ferroelectric liquid crystal elements, as shown in FIG. 3. FIG. 3 is a schematic exploded perspective view illustrating the construction of the right and left eye glass portions 41′ and 42′. The ferroelectric liquid crystal elements of the right and left eye glass portions 41′ and 42′ are surface-stabilized ferroelectric liquid crystal elements. Surface-stabilized ferroelectric liquid crystal elements have fast response times. Since the right and left eye glass portions 41′ and 42′ of the polarized glasses 10 are made up of surface-stabilized ferroelectric liquid crystal elements, the liquid crystal orientations can be changed smoothly at high speed by driving the elements, which is desirable.

In this example, the right eye glass portion 41′ of the polarized glasses 10 includes a quarter-wavelength plate 43a′, a ferroelectric liquid crystal cell 44a′, and a polarizing plate 45a′ arranged in series in the order named. The left eye glass portion 42′, on the other hand, includes a quarter-wavelength plate 43b′, a ferroelectric liquid crystal cell 44b′, and a polarizing plate 45b′ arranged in series in the order named. These right and left eye glass portions 41′ and 42′ and a drive unit (not shown), etc. are fixed to the frame of the polarized glasses.

When the viewer 50 wears the polarized glasses of the present embodiment and faces the liquid crystal display 3, the optical axis of the quarter-wavelength plate 43a′ of the right eye glass portion 41′ is rotated 45° counterclockwise with respect to the horizontal direction, and the transmission axis of the polarizing plate 45a′ is parallel to the horizontal direction, as shown in FIG. 3.

The ferroelectric liquid crystal cell 44a′ has an initial liquid crystal orientation so that the cell 44a′ can be switched between two stable liquid crystal orientation states by applying voltages of appropriate polarities through the drive unit described above. Specifically, in one of the states, the cell 44a′ transmits incident linearly polarized light without changing its characteristics, whereas in the other state the cell 44a′ rotates incident linearly polarized light counterclockwise by 90°.

On the other hand, the optical axis of the quarter-wavelength plate 43b′ of the left eye glass portion 42′ is rotated 45° clockwise with respect to the horizontal direction, and the transmission axis of the polarizing plate 45b′ is parallel to the horizontal direction, as shown in FIG. 3. The ferroelectric liquid crystal cell 44b′ has an initial liquid crystal orientation so that the cell 44b′ can be switched between two stable liquid crystal orientation states by applying voltages of appropriate polarities through the drive unit described above. Specifically, in one of the states, the cell 44b′ transmits incident linearly polarized light without changing its characteristics, whereas in the other state the cell 44b′ rotates incident linearly polarized light clockwise by 90°.

This completes the description of the construction of the stereoscopic image display apparatus 1 of the present embodiment. There will now be described a method of using the stereoscopic image display apparatus 1 so that the viewer 50 can perceive a stereoscopic image from the right and left eye image light.

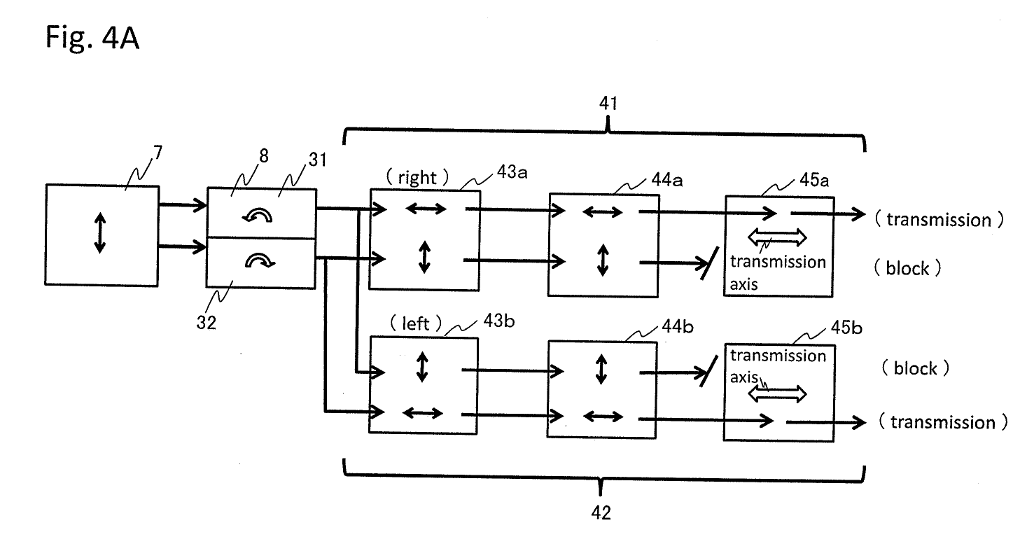

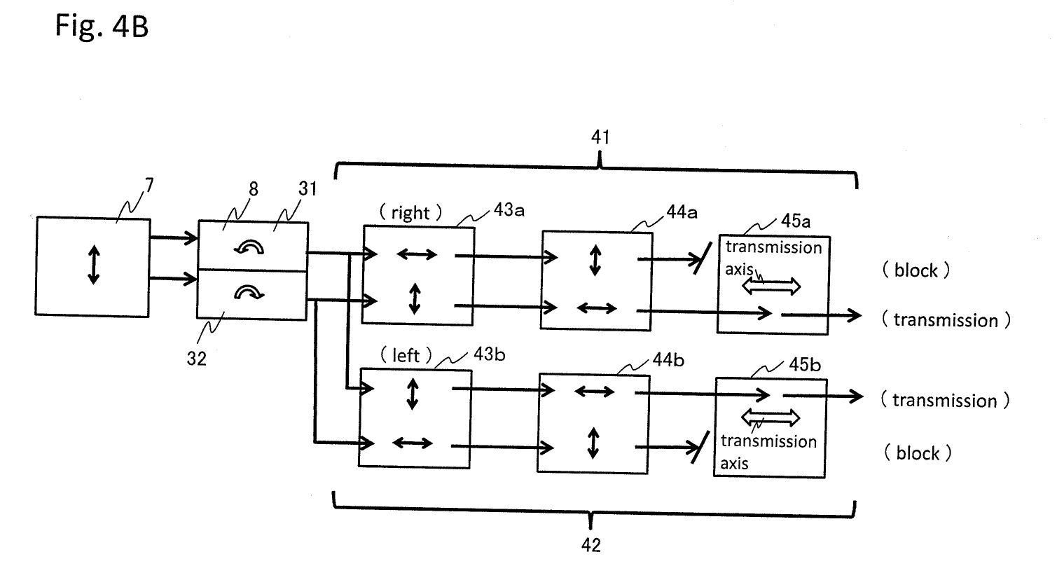

FIG. 4, which includes FIGS. 4A and 4b, is a diagram illustrating the method of using the stereoscopic image display apparatus 1 so that the viewer can perceive a stereoscopic image. FIG. 4A is a diagram illustrating how the viewer perceives a frame image (e.g., an odd frame image), and FIG. 4B is a diagram illustrating how the viewer perceives the next frame image (e.g., an even frame image) after frame switching.

Let it be assumed that the stereoscopic image display apparatus 1 is in operation and use so that the viewer 50 can view a stereoscopic image. When a frame image (e.g., an odd frame image) is displayed, the right and left eye images constituting the frame image are produced in, e.g., the first image forming regions 21 and the second image forming regions 22, respectively, of the liquid crystal panel 6, as described above.

The right eye image light and the left eye image light emerging from the first and second image forming regions 21 and 22, respectively, are polarized by the polarizing plate 7 into linearly polarized light having a horizontal polarization axis and that having a vertical polarization axis, respectively, as indicated by arrows in FIG. 4A.

Both the linearly polarized right eye image light and left eye image light emerging from the polarizing plate 7 are incident to the retarder 8. Specifically, the first polarizing regions 31 of the retarder 8 receive the right eye image light and convert it into counterclockwise circularly polarized light, as indicated by arrows in FIG. 4A. The second polarizing regions 32, on the other hand, receive the left eye image light and convert it into clockwise circularly polarized light, as indicated by arrows in FIG. 4A. The circularly polarized right eye image light and the circularly polarized left eye image light thus formed are incident to the polarized glasses 10 worn by the viewer 50.

When the polarized glasses 10 include the right eye glass portion 41 and the left eye glass portion 42 made up of TN mode liquid crystal elements, appropriate voltages are applied to the TN liquid crystal cells to switch the liquid crystal from the twisted state to the so-called ON state. In this state, the counterclockwise circularly polarized right-eye image light incident to the right eye glass portion 41 is rotated by the quarter-wavelength plate 43a of the right eye glass portion 41 into linearly polarized light parallel to the horizontal direction, which light then travels, without change, through the TN liquid crystal cell 44a in the ON state and through the polarizing plate 45a to the right eye of the viewer 50, as indicated by arrows in FIG. 4A.

On the other hand, the counterclockwise circularly polarized right-eye image light incident to the left eye glass portion 42 is converted by the quarter-wavelength plate 43b of the left eye glass portion 42 into linearly polarized light perpendicular to the horizontal direction, which then passes through the TN liquid crystal cell 44b in the ON state but is blocked by the polarizing plate 45b from reaching the left eye of the viewer 50, as indicated by arrows in FIG. 4A.

Further, the clockwise circularly polarized left-eye image light incident to the left eye glass portion 42 is converted by the quarter-wavelength plate 43b of the left eye glass portion 42 into linearly polarized light parallel to the horizontal direction, which light then travels, without change, through the TN liquid crystal cell 44b in the ON state and through the polarizing plate 45b to the left eye of the viewer 50.

On the other hand, the clockwise circularly polarized left-eye image light incident to the right eye glass portion 41 is converted by the quarter-wavelength plate 43a of the right eye glass portion 41 into linearly polarized light perpendicular to the horizontal direction, which light then passes through the TN liquid crystal cell 44a in the ON state but is blocked by the polarizing plate 45a from reaching the right eye of the viewer 50.

Thus, when the viewer 50 wearing the glasses 10 faces the stereoscopic image display apparatus 1 so that the viewer can receive the right and left eye image light emerging from the first and second polarizing regions 31 and 32, respectively, of the retarder 8, the right eye of the viewer 50 receives only the right eye image light, and the left eye of the viewer 50 receives only the left eye image light, so that the viewer can perceive a stereoscopic image from the right and left eye image light.

Then, when the next frame image (e.g., an even frame image) is displayed on the stereoscopic image display apparatus (after frame switching), the right and left eye images constituting the frame image are produced in the second image forming regions 22 and the first image forming regions 21, respectively, of the liquid crystal panel 6, as shown in FIG. 4B. In this case, the viewer 50 can perceive a stereoscopic image in the following manner.

The left eye image light and the right eye image light emerging from the first and second image forming regions 21 and 22, respectively, of the liquid crystal panel 6 are polarized by the polarizing plate 7 (described later) into linearly polarized light having a horizontal polarization axis and that having a vertical polarization axis, respectively, as indicated by arrows in FIG. 4B and as with the previous frame image.

Both the linearly polarized left eye image light and right eye image light emerging from the polarizing plate 7 are incident to the retarder 8. Specifically, the first polarizing regions 31 of the retarder 8 receive the left eye image light and convert it into counterclockwise circularly polarized light, as indicated by arrows in FIG. 4B. The second polarizing regions 32, on the other hand, receive the right eye image light and convert it into clockwise circularly polarized light, as indicated by arrows in FIG. 4B. The circularly polarized left eye image light and the circularly polarized right eye image light thus formed are incident to the polarized glasses 10 worn by the viewer 50.

When the polarized glasses 10 include the right eye glass portion 41 and the left eye glass portion 42 made up of TN mode liquid crystal elements, no voltage is applied to the TN liquid crystal cells so that the cells remain in the initial liquid crystal orientation state, i.e., the so-called OFF state. In this state, the counterclockwise circularly polarized left-eye image light incident to the right eye glass portion 41 is converted by the quarter-wavelength plate 43a of the right eye glass portion 41 into linearly polarized light parallel to the horizontal direction, which light is then further rotated 90° by the TN liquid crystal cell 44a in the OFF state into linearly polarized light perpendicular to the horizontal direction. The linearly polarized light emerging from the TN liquid crystal cell 44a, however, is blocked by the polarizing plate 45a from reaching the right eye of the viewer 50, as indicated by arrows in FIG. 4B.

On the other hand, the counterclockwise circularly polarized left-eye image light incident to the left eye glass portion 42 is converted by the quarter-wavelength plate 43b of the left eye glass portion 42 into linearly polarized light perpendicular to the horizontal direction, which light is then further rotated 90° by the TN liquid crystal cell 44b in the OFF state into linearly polarized light parallel to the horizontal direction. The linearly polarized light emerging from the TN liquid crystal cell 44b travels, without change, through the polarizing plate 45b to the left eye of the viewer 50, as indicated by arrows in FIG. 4B.

Further, the clockwise circularly polarized right-eye image light incident to the right eye glass portion 41 is converted by the quarter-wavelength plate 43a of the right eye glass portion 41 into linearly polarized light perpendicular to the horizontal direction, which light is then rotated 90° by the TN liquid crystal cell 44a in the OFF state into linearly polarized light parallel to the horizontal direction. The linearly polarized light emerging from the TN liquid crystal cell 44a travels, without change, through the polarizing plate 45a to the right eye of the viewer 50.

On the other hand, the clockwise circularly polarized right-eye image light incident to the left eye glass portion 42 is converted by the quarter-wavelength plate 43b of the left eye glass portion 42 into linearly polarized light parallel to the horizontal direction, which light is then further rotated 90° by the TN liquid crystal cell 44b in the OFF state into linearly polarized light perpendicular to the horizontal direction. The linearly polarized light emerging from the TN liquid crystal cell 44b, however, is blocked by the polarizing plate 45b from reaching the left eye of the viewer 50, as indicated by arrows in FIG. 4B.

Thus, when the viewer 50 wearing the glasses 10 faces the stereoscopic image display apparatus 1 so that the viewer can receive the right and left eye image light emerging from the second and first polarizing regions 32 and 31, respectively, of the retarder 8, the right eye of the viewer 50 receives only the right eye image light, and the left eye of the viewer 50 receives only the left eye image light, so that the viewer can perceive a stereoscopic image from the right and left eye image light. It will be appreciated from the above description of the two successive frame images that although the right and left eye images are switched between the two image forming regions of the liquid crystal display 3 when the liquid crystal display 3 switches from one frame to the next, the right eye of the viewer 50 wearing the polarized glasses 10 always receives only the right eye image light and the left eye of the viewer 50 always receives only the left eye image light. This is accomplished since when the liquid crystal display 3 switches from one frame to the next, the right and left sides of the polarized glasses 10 are switched between two retarding states so that when the right side is in one retarding state, the left side is in the other retarding state, and vice versa. As a result, the viewer 50 can always perceive a stereoscopic image from the right and left eye image light.

Whereas conventional stereoscopic image display apparatuses have the problem of decreased resolution (for example, their vertical resolution may be reduced to half its normal value), the present embodiment avoids such problems, allowing display of an image of as high resolution as possible. Further, conventional stereoscopic image display apparatuses are also disadvantageous in that only one of the right and left eye images of a frame image can be displayed at one time, resulting in a time delay between display of the right and left eye images, from which the viewer perceives a stereoscopic image. On the other hand, in the stereoscopic image display apparatus of the present embodiment, the right and left eye images are always simultaneously displayed on the screen, thereby reducing the eye fatigue of the viewer. Further, the present embodiment eliminates the time delay between display of the right and left eye images of a stereoscopic image, allowing the viewer to see an undisturbed stereoscopic image display of a fast moving object.

Further, the construction of the stereoscopic image display apparatus of the present embodiment allows the use of liquid crystal displays and polarized glasses made up of slow response liquid crystal elements. On the other hand, in accordance with the present embodiment, a stereoscopic image display having a brightness significantly higher than that allowed by the prior art can be produced by employing fast response liquid crystal elements.

The following description will be directed to the polarized glasses 10 which include the right and left eye glass portions 41′ and 42′ made up of ferroelectric liquid crystal elements. Ferroelectric liquid crystal elements can be made to assume two stable liquid crystal orientation states, as described above. When in one of the orientation states, ferroelectric liquid crystal elements transmit incident linearly polarized light without changing its characteristics. That is, this orientation state of the ferroelectric liquid crystal element corresponds to the ON state of the TN mode liquid crystal element described above. On the other hand, when in the other orientation state, ferroelectric liquid crystal elements rotate incident linearly polarized light clockwise or counterclockwise by 90°. That is, this orientation state of the ferroelectric liquid crystal element corresponds to the OFF state of the TN mode liquid crystal element described above. Therefore, the ferroelectric liquid crystal elements of the polarized glasses 10 may be switched between these two stable orientation states by applying voltages thereto. This means that these polarized glasses 10 can have the same polarization effect as the polarized glasses made up of TN mode liquid crystal elements.

It follows from the above description that the image displayed on the stereoscopic image display apparatus can also be stereoscopically viewed with the polarized glasses 10 which include the right and left glass portions 41′ and 42′ made up of ferroelectric liquid crystal elements. Specifically, when the viewer 50 wearing these polarized glasses 10 faces the stereoscopic image display apparatus 1 so that the viewer can receive the right and left eye image light emerging from the first and second polarizing regions 31 and 32 of the retarder 8, the right eye of the viewer 50 receives only the right eye image light, and the left eye of the viewer 50 receives only the left eye image light, so that the viewer 50 can perceive a stereoscopic image from the right and left eye image light.

The operation of the stereoscopic image display apparatus 1 of the present embodiment will now be described.

As described above, in accordance with the present embodiment, the right and left eye images constituting each frame image are simultaneously displayed on the screen, and the resulting right and left eye image light from the screen is converted by the retarder (optical means) described above so that the right and left eyes of the viewer can see the right and left eye images, respectively separately, thereby allowing the viewer to perceive a stereoscopic image. In order to achieve this, the entire image information about each frame, i.e., the entire right and left eye images of the frame, must be displayed on the screen at once. The following method may be useful for that purpose. The right eye image of each frame image is displayed on the entire odd horizontal scan lines of the display screen and the left eye image is displayed on the entire even scan lines, or vice versa. More specifically, when the stereoscopic image display apparatus 1 switches from one frame to the next, the right and left eye images are switched between the odd and even horizontal scan lines so that when the right eye image is displayed on the odd horizontal scan lines, the left eye image is displayed on the even horizontal scan lines, and vice versa. Further, simultaneously, the right and left eye glass portions 41 and 42 of the polarized glasses 10 are also switched between two polarization states so that when the right eye glass portion 41 is in one polarization state, the left eye glass portion 42 is in the other polarization state, and vice versa.

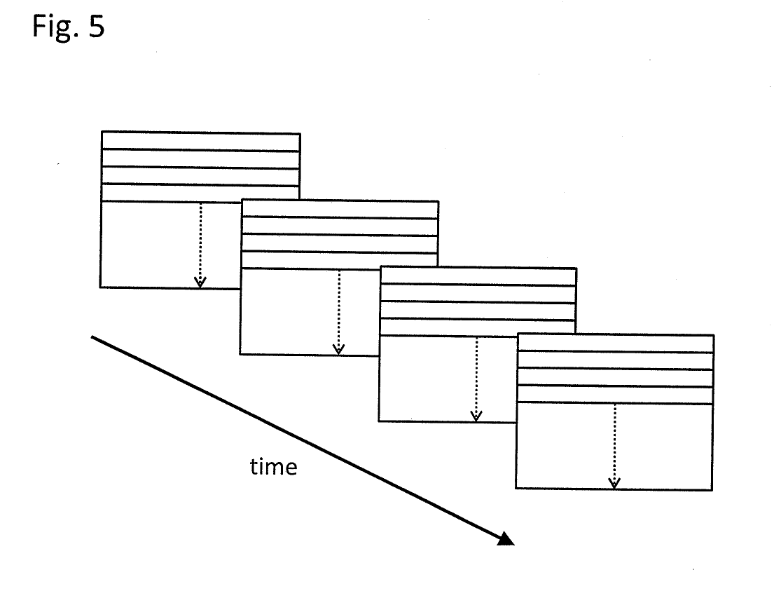

However, in the stereoscopic image display apparatus 1, each frame image is not instantly replaced by the next frame image on the above liquid crystal display 3. The frame image information on the display 3 is updated by overwriting the horizontal lines forming the screen image sequentially from top to bottom, as shown in FIG. 5, which means that the viewer constantly sees each two successive frame images at the same time. This results in increased crosstalk and makes it difficult for the viewer to perceive stereoscopic images from these frame images. It should be noted that FIG. 5 is a diagram illustrating a common method of displaying on a liquid crystal display.

In order to overcome the above problems, the stereoscopic image display apparatus 1 turns on and off the backlight 2 at predetermined intervals to reduce crosstalk.

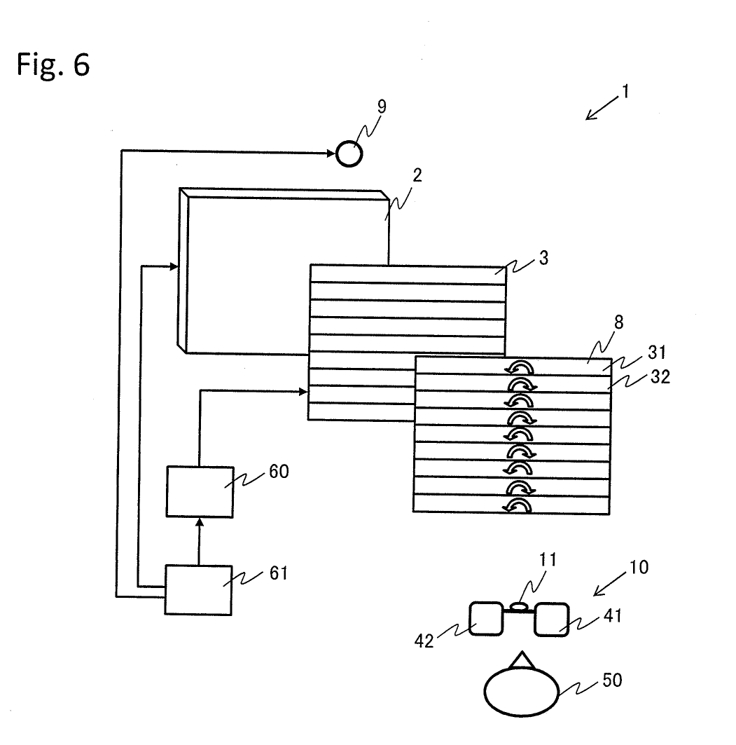

FIG. 6 is a diagram showing the operation of the stereoscopic image display apparatus 1 of the present embodiment.

The stereoscopic image display apparatus 1 of the present embodiment includes the backlight 2, the liquid crystal display 3, and the retarder (optical means) 8 arranged in series in the order named within an enclosure (not shown), as described above. The stereoscopic image display apparatus 1 also includes an image output unit 60 and a display control unit 61 disposed within the above enclosure. Further, the stereoscopic image display apparatus 1 also includes the polarized glasses 10 which is to be worn by the viewer when viewing a stereoscopic image, as described above.

The display control unit instructs the image output unit 60 to output the right and left eye images constituting a frame image to the screen at once. In response, the image output unit 60 outputs and displays the right and left eye images in e.g., the first and second image forming regions 21 and 22, respectively, of the liquid crystal panel 6 of the liquid crystal display 3 shown in FIG. 1.

When the stereoscopic image display apparatus switches from one frame image to the next, the right and left eye images are switched between the first and second image forming regions 21 and 22 so that when the right eye image is displayed in the first image forming regions 21, the left eye image is displayed in the second image forming regions 22, and vice versa. As a result, the right and left eye images of each frame image are “interlaced” with each other. (That is, the horizontal lines forming the right and left eye images are interleaved with each other.) Further, in order to prevent the crosstalk described above, the display control unit 61 controls the image output unit 60, etc. in the following manner. The display control unit 61 causes the image output unit 60 to display the right and left eye images constituting a frame image in the first and second image forming regions, or second and first image forming regions, respectively, of the liquid crystal display 3 during one frame period and then to overwrite the displayed right and left eye images with the same images (i.e., to display the same right and left images in the same image forming regions) during the next frame period. The display control unit 61 causes the image output unit 60 to repeat the same procedure for each successive pair of frame periods.

At the same time the display control unit 61 also controls the turning on and off of the backlight 2 and the switching of the right eye glass portion 41 and the left eye glass portion 42 of the polarized glasses 10 between polarization states. Specifically, the display control unit 61 turns off the backlight 2 each time the right and left eye images are switched between the first and second image forming regions (that is, when the stereoscopic image display apparatus switches from one frame image to the next), and turns it on each time the displayed right and left eye images are overwritten with the same images. This prevents the viewer 50 from seeing two successive frame images at the same time, thus preventing crosstalk.

Further, each time the right and left eye images are switched between the first and second image forming regions (that is, when the stereoscopic image display apparatus switches from one frame image to the next), the display control unit 61 causes the infrared radiator device 9 provided on the enclosure of the liquid crystal display 3 to emit infrared radiation serving as a synchronization signal toward the infrared sensor 11 on the polarized glasses 10 at the start point of the new frame period. Upon the infrared sensor 11 sensing the infrared radiation, the TN liquid crystal cells 44a and 44b of the right and left eye glass portions 41 and 42, respectively, of the polarized glasses 10 are driven into the ON or OFF state so that the right and left eye glass portions 41 and 42 of the polarized glasses 10 are switched between two polarization states.

As described above, the right and left eye images constituting a frame image are simultaneously displayed in the first and second image forming regions, or second and first image forming regions, respectively, of the liquid crystal display 3 during one frame period, and the displayed right and left eye images are overwritten with the same images (i.e., the same right and left images are displayed in the same image forming regions) during the next frame period. This procedure is repeated for each successive pair of frame periods. Further, the right and left glass portions 41 and 42 of the polarized glasses 10 are also switched between two polarization states when one frame image is replaced by the next on the liquid crystal display 3. Specifically, each time the right and left eye images are switched between the first and second image forming regions (i.e., when one frame image is replaced by the next on the liquid crystal display 3), the right and left glass portions 41 and 42 of the polarized glasses 10 are switched between two polarization states at the start point of the new frame period. However, the polarization states of the right and left eye glass portions 41 and 42 are not switched when the displayed right and left eye images are overwritten with the same images. These operations are performed under the control of the display control unit 61.

Thus, although the right and left eye images are switched between the first and second image forming regions when one frame image is replaced by the next, the right eye of the viewer 50 wearing the polarized glasses 10 surely receives only the right eye image light and the left eye of the viewer surely receives only the left eye image light, so that the viewer 50 can always perceive a stereoscopic image from the right and left eye image light without crosstalk.

As described above, the right and left eye images constituting each frame image are simultaneously displayed in the first and second image forming regions, or second and first image forming regions, respectively, of the liquid crystal display 3 during one frame period, and the displayed right and left eye images are overwritten with the same images during the next frame period (i.e., the same right and left eye images are displayed in the same image forming regions during that next frame period). This procedure is repeated for each successive pair of frame periods. This means that, in accordance with the present embodiment, a new frame image is displayed every other frame period and hence the number of frame images displayed on the display per unit time is smaller than when a new frame image is displayed every frame period. Therefore, if the frame frequency is 60 Hz (a typical value), the displayed images are not smooth. Further, in that case, the backlight 2 is turned on and off at a rate of 30 Hz, since it is turned on every other frame period. This may result in the viewer noticing flicker.

Therefore, the frame frequency is preferably 120 Hz or more, which prevents the viewer from perceiving flicker due to the turning on and off the backlight 2 and which allows for smooth image display because of an increase in the number of images displayed per unit time.

It will be noted that when the frame frequency is 240 Hz, the backlight is turned on and off at a rate of 120 Hz. In this case, the right and left eye glass portions 41 and 42 of the polarized glasses 10 are switched between two polarization states at a rate of 60 Hz, since their polarization states remain unchanged during every other frame period (for overwriting). This means that there is no risk that the viewer 50 perceives flicker when the right and left eye glass portions 41 and 42 of the polarized glasses 10 are switched between the two polarization states.

Further, when the frame frequency is 240 Hz, the right and left eye images constituting a frame image may be simultaneously displayed in the first and second image forming regions, or second and first image forming regions, respectively, of the liquid crystal display 3 during one frame period, and the displayed right and left eye images may be overwritten with the same images during the subsequent three frame periods (i.e., the right and left eye images may be displayed in the same image forming regions during those subsequent three frame periods). In this case, the backlight 2 may be turned off only during the first frame period (i.e., the first 1/240 seconds) and turned on during the subsequent three frame periods (the subsequent 3/240 seconds). This procedure may be repeated for each successive four frame periods to increase the luminance across the display of the stereoscopic image display apparatus 1.

The features and advantages of the present invention may be summarized as follows.

In accordance with the first aspect of the present invention, there is provided a stereoscopic image display apparatus in which the left and right eye images constituting each frame image are simultaneously displayed in first and second image forming regions, or second and first image forming regions, respectively, of the display. When the display switches from one frame image to the next, the left and right eye images are switched between the first and second image forming regions. This stereoscopic image display apparatus is constructed so that the right eye of the viewer always sees only right eye image light and the left eye of the viewer always sees only left eye image light even in the event of frame switching, so that the viewer can perceive a stereoscopic image from the right and left eye image light.

Conventional stereoscopic image display apparatuses have the problem of decreased resolution; for example, their vertical resolution may be reduced to half its normal value. On the other hand, the present invention avoids this problem, allowing display of an image of as high resolution as possible.

Further, in accordance with the present invention, right and left eye images are always simultaneously displayed on the display, thereby reducing eye fatigue of the viewer. Further, the present invention eliminates the time delay between display of right and left eye images of a stereoscopic image, allowing the viewer to see an undisturbed stereoscopic image display of a fast moving object.

Further, the present invention allows for the use of liquid crystal displays and polarized glasses made up of slow response liquid crystal elements. On the other hand, in accordance with the present invention, a stereoscopic image display having a brightness significantly higher than that allowed by the prior art can be produced by employing fast response liquid crystal elements.

Obviously many modifications and variations of the present invention are possible in the light of the above teachings. It is therefore to be understood that within the scope of the appended claims the invention may be practiced otherwise than as specifically described.

The entire disclosure of a Japanese Patent Application No. 2009-212530, filed on Sep. 14, 2009 including specification, claims, drawings and summary, on which the Convention priority of the present application is based, are incorporated herein by reference in its entirety.

1. A stereoscopic image display apparatus for projecting parallax images to right and left eyes of a viewer so that the viewer perceives a stereoscopic image, said stereoscopic image display apparatus comprising:
a liquid crystal display including a liquid crystal panel sandwiched between a pair of polarizing plates;
a backlight disposed on a rear side of said liquid crystal display;
optical means disposed on a front side of said liquid crystal display; and
polarized glasses to be worn by the viewer, wherein
said liquid crystal display includes first image forming regions and second image forming regions and simultaneously displays the right eye image and the left eye image constituting each frame image in said first and second image forming regions, or second and first image forming regions, respectively, so that the right and left eye images are interlaced with each other,
when said liquid crystal display switches from one frame image to the next frame image, the right and left eye images are switched between said first and second image forming regions,
said liquid crystal display displays a new frame image every predetermined number of frame periods so that the right and left eye images of the frame image are displayed during the first one of the predetermined number of frame periods and then overwritten with the same right and left eye images during all subsequent frame periods of the predetermined number of frame periods,
lighting state of said backlight is adjusted each time the right and left eye images are switched between said first and second image forming regions,
said optical means includes first polarizing regions and second polarizing regions,
dimensions and position of each first polarizing region correspond to dimensions and positions of the corresponding first image forming region, and dimensions and position of each second polarizing region correspond to dimensions and positions of the corresponding second image forming region,
said first and second polarizing regions are half-wavelength plates or are quarter-wavelength plates having mutually perpendicular optical axes,
said polarized glasses include a right eye glass portion and a left eye glass portion, and
each time the right and left eye images are switched between said first and second image forming regions, said right and left eye glass portions are switched between first and second retarding states so that when said right eye glass portion is in the first retarding state, said left eye glass portion is in the second retarding state, and vice versa.

2. The stereoscopic image display apparatus according to claim 1, wherein:
each of said first and second image forming regions of said liquid crystal display corresponds to one of the horizontal lines of the stereoscopic image display on said liquid crystal display;
said liquid crystal display displays the right and left eye images of each frame image on odd and even horizontal lines, respectively, or even and odd horizontal lines, respectively, so that the right and left eye images are interlaced with each other, each odd horizontal line corresponding to one of said first image forming regions, each even horizontal line corresponding to one of said second image forming regions;
when said liquid crystal display switches from one frame image to the next frame image, the right and left eye images are switched between the odd and even horizontal lines;
said liquid crystal display displays a new frame image every predetermined number of frame periods so that the right and left eye images of the frame image are displayed during the first one of the predetermined number of frame periods and then overwritten with the same right and left eye images during all subsequent frame periods of the predetermined number of frame periods;
the lighting state of said backlight is adjusted each time the right and left eye images are switched between the odd and even horizontal lines;
said optical means includes first polarizing regions and second polarizing regions disposed in an interleaved manner;
dimensions and position of each polarizing region correspond to dimensions and position of the corresponding horizontal line of said liquid crystal display;
said first and second polarizing regions are half-wavelength plates or are quarter-wavelength plates having mutually perpendicular optical axes; and
each time the right and left eye images are switched between the odd and even horizontal lines, said right and left eye glass portions are switched between the first and second retarding states so that when said right eye glass portion is in the first retarding state, said left eye glass portion is in the second retarding state.

3. The stereoscopic image display apparatus according to claim 1, wherein:
said polarized glasses include an infrared sensor, and said liquid crystal display includes an infrared radiator;
each time the right and left eye images are switched between said first and second image forming regions, said infrared radiator emits infrared radiation; and
upon said infrared sensor sensing the infrared radiation, said right and left eye glass portions are switched between the first and second retarding states so that said right eye glass portion is in the first retarding state, said left eye glass portion is in the second retarding state, and vice versa.

4. The stereoscopic image display apparatus according to claim 2, wherein:
said polarized glasses include an infrared sensor, and said liquid crystal display includes an infrared radiator;
each time the right and left eye images are switched between said first and second image forming regions, said infrared radiator emits infrared radiation; and
upon said infrared sensor sensing the infrared radiation, said right and left eye glass portions are switched between the first and second retarding states so that said right eye glass portion is in the first retarding state, said left eye glass portion is in the second retarding state, and vice versa.

5. The stereoscopic image display apparatus according to claim 1, wherein said right and left eye glass portions of said polarized glasses are TN liquid crystal elements or STN liquid crystal elements.

6. The stereoscopic image display apparatus according to claim 2, wherein said right and left eye glass portions of said polarized glasses are TN liquid crystal elements or STN liquid crystal elements.

7. The stereoscopic image display apparatus according to claim 3, wherein said right and left eye glass portions of said polarized glasses are TN liquid crystal elements or STN liquid crystal elements.

8. The stereoscopic image display apparatus according to claim 1, wherein said right and left eye glass portions of said polarized glasses are

9. The stereoscopic image display apparatus according to claim 2, wherein said right and left eye glass portions of said polarized glasses are ferroelectric liquid crystal elements or antiferroelectric liquid crystal elements.

10. The stereoscopic image display apparatus according to claim 3, wherein said right and left eye glass portions of said polarized glasses are ferroelectric liquid crystal elements or antiferroelectric liquid crystal elements.

11. The stereoscopic image display apparatus according to claim 1, wherein said liquid crystal display switches from one frame to the next at a rate of at least 120 Hz.

12. The stereoscopic image display apparatus according to claim 2, wherein said liquid crystal display switches from one frame to the next at a rate of at least 120 Hz.

13. The stereoscopic image display apparatus according to claim 3, wherein said liquid crystal display switches from one frame to the next at a rate of at least 120 Hz.

14. The stereoscopic image display apparatus according to claim 5, wherein said liquid crystal display switches from one frame to the next at a rate of at least 120 Hz.

15. The stereoscopic image display apparatus according to claim 8, wherein said liquid crystal display switches from one frame to the next at a rate of at least 120 Hz.

16. The stereoscopic image display apparatus according to claim 11, wherein said liquid crystal display switches from one frame to the next at a rate of at least 240 Hz.

17. The stereoscopic image display apparatus according to claim 12, wherein said liquid crystal display switches from one frame to the next at a rate of at least 240 Hz.

18. The stereoscopic image display apparatus according to claim 13, wherein said liquid crystal display switches from one frame to the next at a rate of at least 240 Hz.

19. The stereoscopic image display apparatus according to claim 14, wherein said liquid crystal display switches from one frame to the next at a rate of at least 240 Hz.

20. The stereoscopic image display apparatus according to claim 15, wherein said liquid crystal display switches from one frame to the next at a rate of at least 240 Hz.
